(19) United States
(12) Patent Application Publication
(10) Pub. No.: US 2014/0029633 A1
(43) Pub. Date: Jan. 30, 2014

(54) COMMUNICATION APPARATUS, COMMUNICATION SYSTEM, SYNCHRONOUS PROCESSING METHOD, AND PROGRAM

(71) Applicant: Sony Corporation, Tokyo (JP)

(72) Inventors: Toshihiko Hamamatsu, Saitama (JP); Ikuo Someya, Tokyo (JP); Toshiaki Kojima, Kanagawa (JP)

(73) Assignee: Sony Corporation, Tokyo (JP)

(21) Appl. No.: 13/946,232

(22) Filed: Jul. 19, 2013

(30) Foreign Application Priority Data
Jul. 26, 2012 (JP) 2012-165355

(51) Int. Cl. H04J 3/06

(52) U.S. Cl. CPC H04J 3/0635
USPC 370/509

(57) ABSTRACT

A communication apparatus includes a data processing unit and a communication unit. The data processing unit performs a clock synchronous process between the communication apparatus and a communication correspondent apparatus. The communication unit performs communication with the communication correspondent apparatus. The data processing unit compares, when the clock synchronous process is performed, an offset window that defines a permissible delay time range of a packet applied to the synchronous process and a network delay time of the synchronous packet, selects the synchronous packet having the network delay time within the offset window, and applies phase offset information calculated from the synchronous packet, to perform phase control, and decreases a width of a current offset window when the network delay time of the synchronous packet is within the current offset window and increases the current offset window width when the network delay time is outside of the current offset window.

### BACKGROUND

The present disclosure relates to a communication apparatus, a communication system, a synchronous processing method, and a program. In particular, the present disclosure relates to a communication apparatus, a communication system, a synchronous processing method, and a program for performing a clock synchronous process among a plurality of apparatuses connected to one another via a network.

There is a case where a synchronous process is necessary among communication apparatuses when communication is performed via a network, and a process is performed for communication data, for example.

For example, in the case where a content for a TV broadcast is generated, when images taken by a plurality of video cameras placed on a plurality of different positions are transmitted to an edit studio via a network, and the images are edited with an edit apparatus in the edit studio, a synchronous process is necessary among the communication apparatuses including the cameras. The edit apparatus in the edit studio selects one image from the plurality of taken images received from the plurality of cameras, sequentially switches an image selected, and generates a content for a broadcast.

In such an edit process, it is necessary to correctly determine timings when the images are individually taken by the cameras. Unless a shoot time by each of the cameras is grasped correctly, for example, at a time switching a camera image, an image in which a continuous motion is not obtained may be output as a broadcast image.

In many cases, a time stamp that indicates a shoot time is set for each of the images taken by the cameras, and the edit apparatus performs an edit process with reference to the time stamp.

However, the time stamp is set by using a clock signal transmitted from a clock incorporated in each of apparatuses connected to each other via a network. If there is a phase shift or a frequency drift in the clock signal of the apparatuses connected via the network, a lag is caused between the time stamps set in the individual apparatuses.

To correct the lag of the clock signals between the apparatuses connected via the network, a clock synchronous process is performed in which a synchronous packet is transmitted and received among the network-connected apparatuses.

For example, Japanese Patent Application Laid-open No. 2010-190635 discloses, as a related art, a synchronous process among a plurality of apparatuses connected via a packet transmission network such as Ethernet (registered trademark).

In Japanese Patent Application Laid-open No. 2010-190635, the structure is disclosed in which a synchronous packet is transmitted and received between a master apparatus and a slave apparatus that perform the synchronous process, and an analysis is performed to which packet transmission time information and packet reception time information recorded for the packet are applied, thereby performing the clock synchronous process between the master and slave apparatuses.

However, in so-called a cross traffic structure in which a high-speed, large-volume data storage packet like a movie signal and a synchronous packet for the synchronous process described above are transmitted and received by using the same network, a network delay due to a transmission load, congestion, or the like may occur.

Such a network delay can occur in various communication processes, for example, in a “going” direction of a packet from the master apparatus to the slave apparatus, a “return” direction of a packet from the slave apparatus to the master apparatus, or a “reciprocation” direction, which corresponds to both of the going and return directions.

If a synchronous process is performed by using such a synchronous packet that a large delay is generated, there is a possibility that an incorrect process is performed, and a highly accurate synchronous process is difficult to be performed.

### SUMMARY

In view of the above-mentioned circumstances, it is desirable to provide a communication apparatus, a communication system, a synchronous processing method, and a program capable of performing a highly accurate clock synchronous process even in such a communication condition that a network delay is generated.

According to an embodiment of the present disclosure, there is provided a communication apparatus including a data processing unit and a communication unit. The data processing unit is configured to perform a clock synchronous process between the communication apparatus and a communication correspondent apparatus, and the communication unit is configured to perform communication with the communication correspondent apparatus.

The data processing unit compares, when the clock synchronous process accompanied by transmission and reception of a synchronous packet to and from the communication correspondent apparatus is performed, an offset window that defines a permissible delay time range of a packet applied to the synchronous process and a network delay time of the synchronous packet with each other, selects the synchronous packet having the network delay time within the offset window, and applies phase offset information calculated from the synchronous packet selected, to perform phase control.

The data processing unit performs an offset window width update process of decreasing a width of a current offset window in a case where the network delay time of the synchronous packet is within the current offset window and increasing the width of the current offset window in a case where the network delay time of the synchronous packet is outside of the current offset window.

Further, in the communication apparatus according to the embodiment of the present disclosure, the data processing unit decreases the width of the current offset window by a fixed width predefined in a case where the network delay time of the synchronous packet is within the current offset window, and increases the width of the current offset window by the fixed width predefined in a case where the network delay time of the synchronous packet is outside of the current offset window.

Further, in the communication apparatus according to the embodiment of the present disclosure, the data processing unit decreases the width of the current offset window by a fixed decrease rate predefined in a case where the network delay time of the synchronous packet is within the current offset window, and increases the width of the current offset window by a fixed increase rate predefined in a case where the network delay time of the synchronous packet is outside of the current offset window.

Further, in the communication apparatus according to the embodiment of the present disclosure, the data processing unit sets an increase of the width of the offset window to be larger in accordance with a successive count of an increasing process for the width of the offset window, and sets a decrease of the width of the offset window to be larger in accordance with a successive count of a decreasing process for the width of the offset window.

Further, in the communication apparatus according to the embodiment of the present disclosure, the data processing unit performs the increasing and decreasing process for the width of the offset window within a range from an upper limit value to a lower limit value of the offset window width predefined.

Further, in the communication apparatus according to the embodiment of the present disclosure, the data processing unit calculates, as the network delay, a sum of a time period necessary for the reception of the synchronous packet from the communication correspondent apparatus and a time period necessary for the transmission of the synchronous packet to the communication correspondent apparatus.

Further, in the communication apparatus according to the embodiment of the present disclosure, the data processing unit updates a minimum value as an end of the offset window on the basis of delay time data of the synchronous packet which is calculated sequentially.

According to another embodiment of the present disclosure, there is provided a communication system including a first communication apparatus and a second communication apparatus configured to perform communication with the first communication apparatus.

The first communication apparatus includes a data processing unit configured to perform a clock synchronous process between the first communication apparatus and the second communication apparatus, and a communication unit configured to perform communication with the second communication apparatus.

The data processing unit compares, when the clock synchronous process accompanied by transmission and reception of a synchronous packet to and from the second communication apparatus is performed, an offset window that defines a permissible delay time range of a packet applied to the synchronous process and a network delay time of the synchronous packet with each other, selects the synchronous packet having the network delay time within the offset window, and applies phase offset information calculated from the synchronous packet selected, to perform phase control.

The data processing unit performs an offset window width update process of decreasing a width of a current offset window in a case where the network delay time of the synchronous packet is within the current offset window and increasing the width of the current offset window in a case where the network delay time of the synchronous packet is outside of the current offset window.

According to another embodiment of the present disclosure, there is provided a synchronous processing method for performing a clock phase synchronous process in a communication apparatus including a data processing unit configured to perform a clock synchronous process between the communication apparatus and a communication correspondent apparatus and a communication unit configured to perform communication with the communication correspondent apparatus.

The synchronous processing method includes comparing, when the clock synchronous process accompanied by transmission and reception of a synchronous packet to and from the communication correspondent apparatus is performed, an offset window that defines a permissible delay time range of a packet applied to the synchronous process and a network delay time of the synchronous packet with each other, selecting the synchronous packet having the network delay time within the offset window, and applying phase offset information calculated from the synchronous packet selected, to perform phase control by the data processing unit, and performing an offset window width update process of decreasing a width of a current offset window in a case where the network delay time of the synchronous packet is within the current offset window and increasing the width of the current offset window in a case where the network delay time of the synchronous packet is outside of the current offset window by the data processing unit.

According to another embodiment of the present disclosure, there is provided a program causing a clock phase synchronous process to be performed in a communication apparatus. The communication apparatus includes a data processing unit configured to perform a clock synchronous process between the communication apparatus and a communication correspondent apparatus and a communication unit configured to perform communication with the communication correspondent apparatus.

The program causes the data processing unit to perform the steps of comparing, when the clock synchronous process accompanied by transmission and reception of a synchronous packet to and from the communication correspondent apparatus is performed, an offset window that defines a permissible delay time range of a packet applied to the synchronous process and a network delay time of the synchronous packet with each other, selecting the synchronous packet having the network delay time within the offset window, and applying phase offset information calculated from the synchronous packet selected, to perform phase control by the data processing unit, and performing an offset window width update process of decreasing a width of a current offset window in a case where the network delay time of the synchronous packet is within the current offset window and increasing the width of the current offset window in a case where the network delay time of the synchronous packet is outside of the current offset window by the data processing unit.

It should be noted that the program according to the present disclosure is a program that can be provided to an information processing apparatus or a computer system capable of executing various program codes by a storage medium or a communication medium computer-readable. Such a program is provided in a computer-readable form, thereby attaining the process in accordance with the program on the information processing apparatus or the computer system.

Further another feature and advantage of the present disclosure will be revealed by the following embodiment of the present disclosure and detailed description based on the attached drawings. It should be noted that a system in the specification refers to a logically assembled structure of a plurality of apparatuses, and the apparatuses are not necessarily be provided in the same casing.

According to the embodiment of the present disclosure, the highly accurate clock synchronous process in the communication apparatus is attained.

Specifically, the communication apparatus includes the data processing unit and the communication unit. The data processing unit is configured to perform a clock synchronous process between the communication apparatus and a communication correspondent apparatus, and the communication unit is configured to perform communication with the communication correspondent apparatus. The data processing unit compares, when the clock synchronous process accompanied by transmission and reception of a synchronous packet to and from the communication correspondent apparatus is performed, an offset window that defines a permissible delay time range of a packet applied to the synchronous process and a network delay time of the synchronous packet with each other, selects the synchronous packet having the network delay time within the offset window, and applies phase offset information calculated from the synchronous packet selected, to perform phase control. The data processing unit performs an offset window width update process of decreasing a width of a current offset window in a case where the network delay time of the synchronous packet is within the current offset window and increasing the width of the current offset window in a case where the network delay time of the synchronous packet is outside of the current offset window.

With this structure, under the setting of the optimal window width which fits to the current condition, it is possible to select the synchronous packet for performing reliable synchronous control and perform the highly accurate clock synchronous process.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram for explaining the structure and process of communication apparatuses that perform a clock synchronous process;

FIG. 2 is a diagram for explaining a specific example of the clock synchronous process;

FIG. 3 is a diagram for explaining a communication sequence in the clock synchronous process performed between the communication apparatuses;

FIG. 4 is a diagram for explaining an example of an offset window applied to a phase synchronous process and a distribution of a reciprocation delay time of a synchronous packet;

FIG. 5 is a diagram for explaining an apparatus that performs the phase synchronous process to which the offset window is applied and an example of the process;

FIG. 6 is a diagram for explaining a network delay time applied to the phase synchronous process to which the offset window is applied;

FIG. 7 is a diagram for explaining an apparatus that performs the phase synchronous process by sequentially changing the size of the offset window and an example of the process; and

FIG. 8 is a diagram for explaining an example of a scale-up and -down algorism of the offset window.

### DETAILED DESCRIPTION OF EMBODIMENTS

Hereinafter, with reference to the drawings, a detailed description will be given on a communication apparatus, a communication system, a synchronous processing method, and a program according to the present disclosure. It should be noted that the description will be given in the following items.

1. About outline of clock synchronous process using synchronous packet

2. About synchronous process by setting of offset window

3. About basic process of synchronous process to which offset window is applied

4. About process example in which sequential scaling process for offset window is performed

5. About example of offset scaling process algorithm

6. Conclusion of structure of present disclosure

(1. About Outline of Clock Synchronous Process Using Synchronous Packet)

First, the outline of a clock synchronous process using a synchronous packet will be described.

Hereinafter, as an example of the clock synchronous process using the synchronous packet, a clock synchronous sequence defined in IEEE1588 will be described.

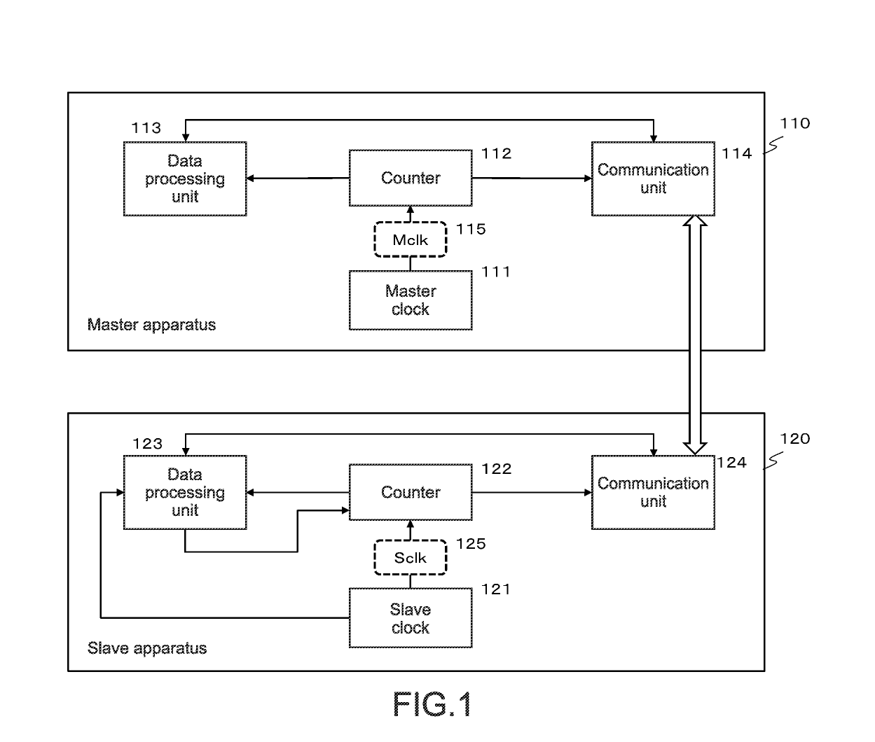

FIG. 1 is a diagram showing a master apparatus 110 and a slave apparatus 120 as two apparatuses that perform a clock synchronous process. The master apparatus 110 and the slave apparatus 120 transmit and receive a packet to and from each other via an IP communication network such as Ethernet (registered trademark), which is an asynchronous transmission network.

Specifically, for example, the slave apparatus 120 is a video camera, and the master apparatus 110 is an edit apparatus that receives an image of the video camera and performs an edit process.

The master apparatus 110 includes a master clock 111, a counter 112, a data processing unit 113, and a communication unit 114.

The master clock 111 generates a master clock signal (Mclk) 115 and outputs the clock signal to the counter 112.

The counter 112 generates a counter value based on the master clock signal (Mclk) 115 input from the master clock 111 and outputs the value to the data processing unit 113.

The data processing unit 113 inputs the counter value generated by the counter 112 and performs various data processes on the basis of the counter value.

The data processing unit 113 performs a process for the clock synchronous process, a process in accordance with apparatuses, such as an obtaining process for video camera shoot data if the master apparatus 110 is a video camera, a time stamp setting process based on the counter value, and the like.

Further, if the master apparatus 110 is an edit apparatus that edits a content received from the slave apparatus which is the video camera, a content edit process using a time stamp set for the content is performed, for example.

The data processing unit 113 is constituted of a CPU having a program execution function, a memory that stores a program, data, various parameters, etc., and the like.

The data processing unit 113 executes the program read from the memory and performs a clock synchronous process or the like to be described below, for example.

The communication unit 114 transmits and receives a packet to and from the slave apparatus 120.

The slave apparatus 120 includes a slave clock 121, a counter 122, a data processing unit 123, and a communication unit 124.

The slave clock 121 generates a slave clock signal (Sclk) 125 and outputs the clock signal generated to the counter 122.

The counter 122 generates a counter value based on the slave clock signal (Sclk) 125 input from the slave clock 121 and outputs the value to the data processing unit 123.

The data processing unit 123 inputs the counter value generated by the counter 122 and performs various data processes on the basis of the counter value.

The data processing unit 123 performs a process for the clock synchronous process, a process in accordance with apparatuses, such as an obtaining process for video camera shoot data if the slave apparatus 120 is a video camera, a time stamp setting process based on the counter value, and the like.

Further, if the slave apparatus 120 is an edit apparatus that edits a content received from the master apparatus which is the video camera, a content edit process using a time stamp set for the content is performed, for example.

The data processing unit 123 is constituted of a CPU having a program execution function, a memory that stores a program, data, various parameters, etc., and the like.

The data processing unit 123 executes the program read from the memory and performs a clock synchronous process or the like to be described below, for example.

The communication unit 124 transmits and receives a packet to and from the master apparatus 110.

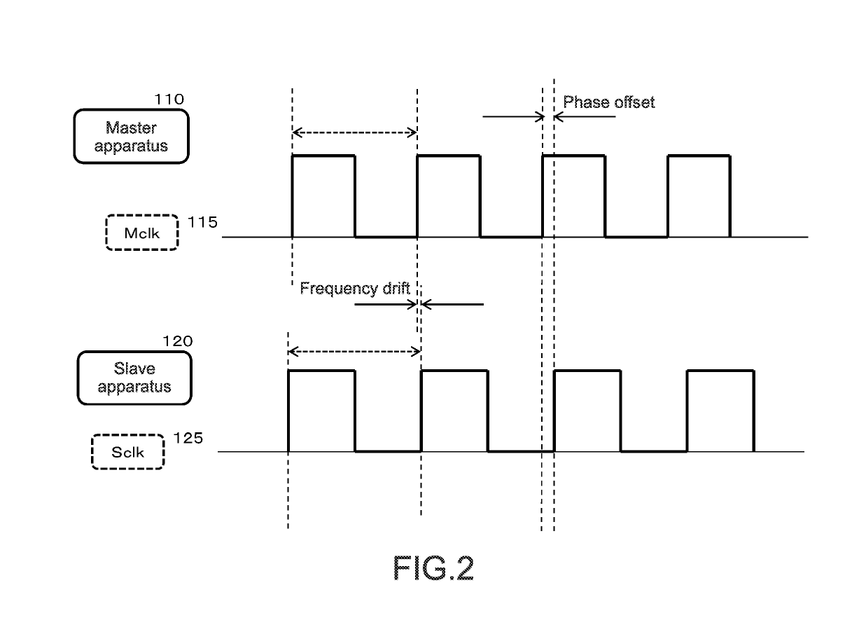

Here, the clock signal (Mclk) generated by the master clock 111 of the master apparatus 110 and the clock signal (Sclk) generated by the slave clock 121 of the slave apparatus 120 are not necessarily be synchronous. That is, generally, as shown in FIG. 2, a frequency drift and a phase offset are caused.

In the case where the data communication is performed between the master apparatus 110 and the slave apparatus 120 which have such asynchronous clocks, it may be necessary to perform a clock synchronous process.

In other words, in the case where the data edit or the like based on the time stamp as described above is performed, a clock synchronization is necessary.

There are various methods for the clock synchronous process. For example, in IEEE1588, one clock synchronous process sequence is defined.

In the following, the clock synchronous process sequence of IEEE1588 will be described.

In the clock synchronization according to the IEEE1588 sequence, the master apparatus 110 transmits a PTP (precision time protocol) message to the slave apparatus 120.

The PTP message is a message packet in which message transmission time information or the like is stored, for example. It should be noted that, for the time information, a value obtained by converting the counter value set in the counter 112 of the master apparatus 110 into a value in unit of nanosecond (ns) as time information is used. For the conversion process, the data processing unit 113 of the master apparatus 110 is equipped with a function for converting the counter value to a time information value in unit of nanosecond (ns).

In a synchronous packet transmission process of one unit, in the PTP message transmitted from the master apparatus 110 to the slave apparatus 120, a synchronization message (Sync) and a delay response message (RelayResponse) are included.

The synchronization message (Sync) is a message in which time information for performing time synchronization is stored. The master apparatus 110 continuously transmits a plurality of synchronization messages (Sync). It should be noted that a synchronization message (Sync) subsequent to the preceding synchronization message (Sync) may be referred to as a follow-up message.

The delay response message is a message that is transmitted as a response after a delay request (DelayRequest) message is received from the slave apparatus 120, and is a message in which reception time information of the delay request (DelayRequest) message from the slave apparatus 120.

The slave apparatus 120 receives the PTP message from the master apparatus 110, and the PTP message generated by the slave apparatus is transmitted to the master apparatus 110.

The PTP message transmitted to the master apparatus 110 from the slave apparatus 120 is the delay request (DelayRequest) message.

After the synchronization message (Sync) is received from the master apparatus 110, the delay request message is transmitted in order to request a delay response message to the master apparatus 110.

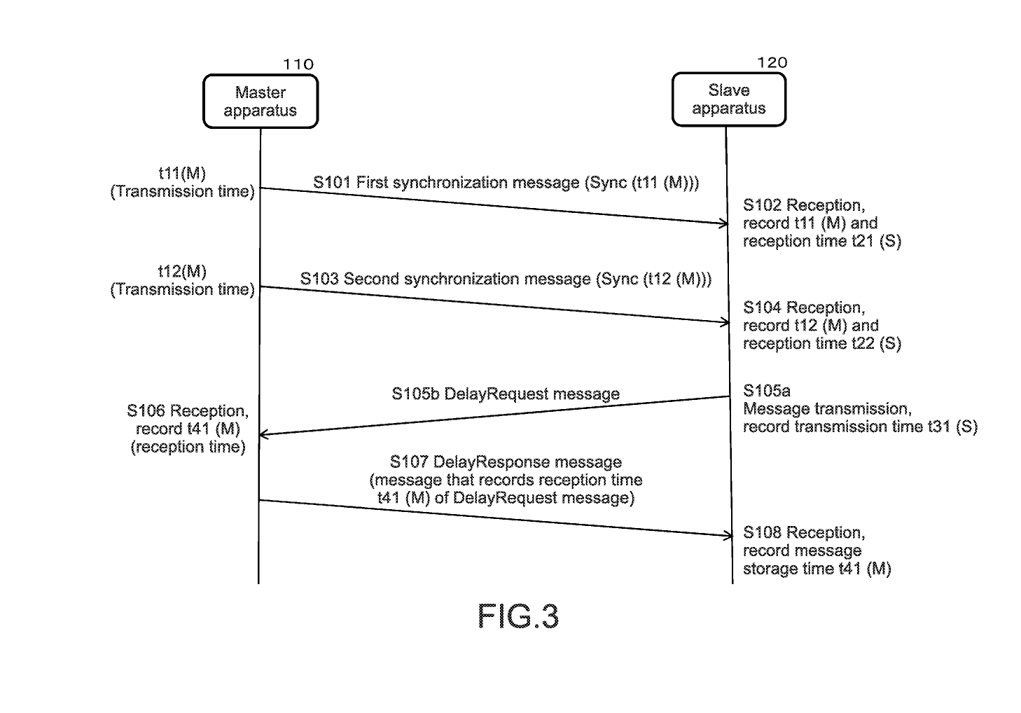

FIG. 3 is a sequence diagram for explaining the clock synchronous process sequence between the master apparatus 110 and the slave apparatus 120 shown in FIG. 1.

The processes of Steps S101 to S108 will be described.

(Step S101)

A first synchronization message (Sync (t11)) is transmitted from the master apparatus 110 to the slave apparatus 120.

In the first synchronization message (Sync (t11)), a transmission time t11 of the first synchronization message is stored. This is time information (t11(M)) based on the master clock (Mclk).

Hereinafter, for time information measured with the master clock as a reference clock and time information measured with the slave clock as a reference clock, (M) and (S) are respectively added to pieces of time information (txy).

(Step S102)

The slave apparatus 120 receives the first synchronization message (Sync (t11(M))) transmitted from the master apparatus 110, and the message transmission time information (t11(M)) stored in the first synchronization message (Sync (t11(M))) received and a message reception time, that is, reception time information (t21(S)) based on the slave clock (Sclk) are recorded in the memory.

(Step S103)

A second synchronization message (Sync (t12(M))) is transmitted from the master apparatus 110 to the slave apparatus 120.

In the second synchronization message (Sync (t12(M))), a transmission time t12 of the second synchronization message is stored. This is time information (t12(M)) based on the master clock (Mclk).

(Step S104)

The slave apparatus 120 receives the second synchronization message (Sync (t12(M))) transmitted from the master apparatus 110 and records the message transmission time information (t12(M)) stored in the synchronization message (Sync (t12(M))) received and a message reception time, that is, reception time information (t22(S)) based on the slave clock (Sclk) in the memory.

(Steps S105a, S105b)

Next, from the slave apparatus 120 to the master apparatus 110, the delay request message (DelayRequest) is transmitted.

The slave apparatus 120 records an issuance (transmission) time t31(S) of the delay request message as time information (t31(S)) based on the slave clock (Sclk) in the memory.

(Step S106)

The master apparatus 110 receives the delay request message transmitted from the slave apparatus 120 and records a reception time t41(M) of the delay request message, that is, time information (t41(M)) based on the master clock (Mclk) in the memory.

(Step S107)

Next, the delay response message (DelayResponse) is transmitted from the master apparatus 110 to the slave apparatus 120.

In the delay response message, the delay request message reception time t41, that is, the time information (t41(M)) based on the master clock (Mclk) is stored.

(Step S108)

The slave apparatus 120 receives the delay response message transmitted from the master apparatus 110, obtains the delay request message reception time t41(M), that is the time information based on the master clock (Mclk), and records the time information in the memory.

Through those processes, the following time information is recorded in the memory of the slave apparatus 120.

(1) t11(M): time information based on the master clock (Mclk) which indicates the transmission time of the first synchronization message

(2) t21(S): time information based on the slave clock (Sclk) which indicates the reception time of the first synchronization message

(3) t12(M): time information based on the master clock (Mclk) which indicates the transmission time of the second synchronization message

(4) t22(S): time information based on the slave clock (Sclk) which indicates the reception time of the second synchronization message

(5) t31(S): time information based on the slave clock (Sclk) which indicates the transmission time of the delay request message

(6) t41(M): time information based on the master clock (Mclk) which indicates the reception time of the delay request message

The data processing unit 123 of the slave apparatus 120 applies those time information items to calculate the phase offset and the frequency drift between the master clock signal (Mclk) generated by the master clock 111 of the master apparatus 110 and the slave clock signal (Sclk) generated by the slave clock 121 of the slave apparatus 120, and executes the clock synchronous process on the basis of the frequency drift and the phase offset calculated.

Specifically, for example, the data processing unit 123 of the slave apparatus 120 outputs a correction signal to the counter 122 to correct the counter value based on the slave clock signal (Sclk) generated by the slave clock 121 to be the same as the counter value based on a signal synchronized with the master clock. Through this process, the difference of the slave clock 121 with respect to the master clock 111 is corrected, with the result that the synchronization is achieved.

It should be noted that the processes of Steps S101 to S108 shown in FIG. 3 indicate the process sequence in one unit of a synchronous process algorithm. Between actual communication apparatuses, in an execution period of a communication process, the processes of Steps S101 to S108 are repeatedly performed, and a process for maintaining the synchronization of the communication apparatuses is performed.

For example, synchronization message packets of 64 packets per second are successively transmitted from the master apparatus to the slave apparatus, and through a control process using those packets, the process for maintaining the synchronization between the two communication apparatuses (master and slave) is performed.

It should be noted that in the synchronous process executed by the data processing unit 123 of the slave apparatus 120, the following process is performed, for example.

The data processing unit 123 generates a control voltage in accordance with the difference amount of the slave clock 121 with respect to the master clock 111, the control voltage is output to a VCO (voltage controlled oscillator), the VCO output is input to the counter 122, and a PID control of the count process of the counter 122 is performed. Such a servo process or the like is performed.

It should be noted that the frequency drift and the phase offset are calculated from the following Expressions 1 and 2.

Frequency drift=(t12(M)−t11(M))−(t22(S)−t21(S)) Expression 1

Phase offset={(t22(S)−t12(M))−(t41(M)−t31(S))}/2 Expression 2

The data processing unit 123 of the slave apparatus 120 calculates the frequency drift and the phase offset between the master clock (Mclk) and the slave clock (Sclk) from the above Expressions 1 and 2, to generate the correction signal on the basis of the calculation result.

The correction signal is input to the counter 122, and a counter value generated on the basis of the slave clock (Sclk) is controlled, thereby executing the synchronous process.

It should be noted that the synchronous process is continuously executed in the data communication period between the master apparatus and the slave apparatus.

(2. About Synchronous Process by Setting of Offset Window)

As described above, the synchronous process between the communication apparatuses connected via the network is performed by transmitting and receiving the plurality of message packets such as the synchronization message via the network.

The phase shift obtained from the Expression 2 above corresponds to a time difference between the master clock (Mclk) and the slave clock (Sclk). That is, the following relationship is established.

Time difference=Phase offset={(t22(S)−t12(M))−(t41(M)−t31(S)}/2

Here, packet transmission from the master apparatus to the slave apparatus is referred to as “going” hereinafter, and packet transmission from the slave apparatus to the master apparatus is referred to as “return” hereinafter.

A “reciprocation delay”, which is a value of the sum of network delays of “going” and “return”, can be expressed by the following Expression 3.

Reciprocation delay={(t22(S)−t12(M))−(t41(M)−t31(S)}/2 Expression 3

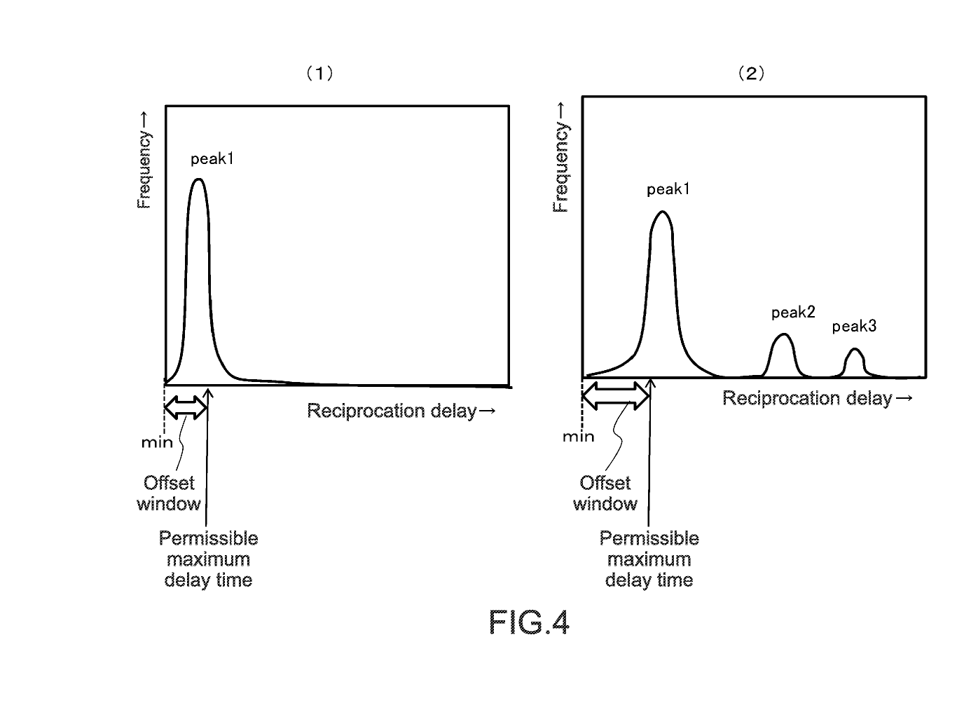

In the case where there is no transmission load between the master apparatus and the slave apparatus, a time period necessary for the synchronous packet communication process is the shortest time period in both the cases of the going and the return. For example, a time period necessary for the packet communication process transmitted and received between the master apparatus and the slave apparatus in accordance with the sequence diagram shown in FIG. 3 is the shortest time period in both the cases of the going and the return, for example. Therefore, a frequency distribution of the reciprocation delay is as shown in the graph (1) of FIG. 4.

In the graph (1) of FIG. 4, the transverse axis corresponds to the reciprocation delay time, and the vertical axis corresponds to the frequency corresponding to the number of packets having the reciprocation delay times.

In the case where there is no transmission load between the master apparatus and the slave apparatus, the reciprocation delays are concentrated on one peak (peak 1).

However, in the cross traffic structure in which high-speed, large-volume data storage packets such as move signals via the same network along with the synchronous packets for the synchronous process described above between the master apparatus and the slave apparatus, the network delay is generated due to the transmission load, the congestion, or the like, and a variation in delay amount is also caused.

The network delay can be generated in various communication processes in the “going” direction of the packets from the master to the slave, the “return” direction of the slave to the master, or the “reciprocation” direction, which corresponds to both the directions.

In the network in such a condition, the frequency distribution of the reciprocation delays of the synchronous packets is as shown in the graph (2) of FIG. 4.

Like the graph (1) of FIG. 4, in the graph (2) of FIG. 4, the transverse axis corresponds to the reciprocation delay time, and the vertical axis corresponds to the frequency corresponding to the number of packets having the reciprocation delay times.

In the case where there is a transmission load between the master apparatus and the slave apparatus, the reciprocation delays form a plurality of peaks (peak 1, peak 2, and peak 3) as shown in the graph (2) of FIG. 4.

It is estimated that those peaks are caused due to the following delay occurrence.

Peak 1: Case where there is almost no delay in both of the going and the return

Peak 2: Case where the delay is caused in one of the going and the return

Peak 3: Case where the delay is caused in both of the going and the return

The peaks of the reciprocation delay vary depending on the variation of a network load due to large-volume data packets such as movie signals transmitted and received along with the synchronous packets.

As shown in the graph (2) of FIG. 4, in the environment in which synchronous packets at various delay times are generated, a highly accurate synchronous process is difficult.

In such a situation, a method for improving the accuracy of the synchronous process is to perform the synchronous process by selectively using only synchronous packets with small reciprocation delay times.

For example, only synchronous packets that fall within a certain range from a minimum value (min) of the reciprocation delay time are selected and used to perform the synchronous process.

To select the packets with small delay times, an offset window is used. The offset window is a time frame corresponding to the delay time for selecting a packet from the minimum value (min) of the reciprocation delay time to a permissible maximum delay time as the packet to be applied to the synchronous process.

In the example shown in the graph (1) of FIG. 4, the offset window is set within a time section from the minimum value (min) of the reciprocation delay time to the permissible maximum delay time. Such a synchronous packet that the reciprocation delay time is within the offset window is selected as the packet applied to the synchronous process. For the synchronous packet that is outside of the offset window, a process for not applying the packet to the synchronous process is performed.

In the example shown in the graph (2) of FIG. 4, the offset window is also set. Only a synchronous packet that the reciprocation delay time is within the offset window is selected as the packet applied to the synchronous process. For the synchronous packet that is outside of the offset window, such a setting as not to apply the packet to the synchronous process is effective.

However, as shown in the graph (2) of FIG. 4, in the case where there are a lot of packets with large reciprocation delay times, the number of synchronous packets within the offset window becomes small. That is, there arises a problem that the number of synchronous packets per unit time applicable to the synchronous process becomes small.

In particular, if a period with large network delay is continuously generated, the synchronous packet within the offset window is not completely generated for a certain period of time, with the result that it may be impossible to perform the synchronous process for a long time period.

As a result, an interval between the synchronous packets for performing the synchronous process is generated, and a large phase offset of the clocks between the master apparatus and the slave apparatus may be caused as time goes by. If such a situation occurs once, it takes longer time to establish the synchronization thereafter.

(3. About Basic Process of Synchronous Process to Which Offset Window is Applied)

Before the synchronous process performed in the communication apparatuses according to the present disclosure is described, a basic example of the synchronous process to which the offset window is applied will be described.

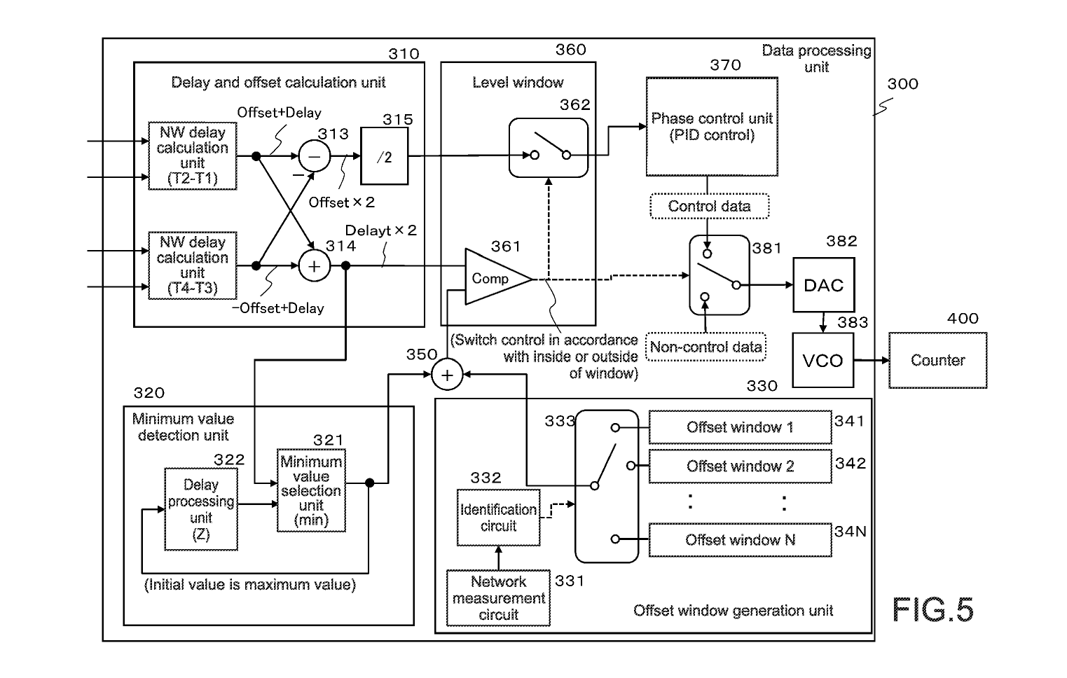

FIG. 5 is a diagram showing an example of the structure of a data processing unit of a communication apparatus that performs a basic synchronous process to which the offset window is applied.

A data processing unit 300 shown in FIG. 5 corresponds to the data processing unit 123 of the slave apparatus 120 shown in FIG. 1, for example.

As described above with reference to FIG. 3, the slave apparatus 120 transmits and receives the synchronous packets of the synchronization message (Sync), the delay request (DelayRequest) message, and the like to and from the master apparatus 110, to perform the synchronous process.

The data processing unit 123 of the slave apparatus 120 calculates the phase offset and the frequency drift between the master clock (Mclk) and the slave clock (Sclk) on the basis of the Expressions 1 and 2 described above and generates a correction signal on the basis of the calculation result. The correction signal is input to the counter 122, and a counter value generated on the basis of the slave clock (Sclk) is controlled, to perform the synchronous process.

A process example described in the following is a process example in which the control for the phase offset between the master clock (Mclk) and the slave clock (Sclk), that is, the control for the time difference between the master clock (Mclk) and the slave clock (Sclk) is performed.

The data processing unit 300 shown in FIG. 5 generates a control signal for controlling the phase offset between the master clock (Mclk) and the slave clock (Sclk), that is, the time difference therebetween and outputs the signal to a counter 400.

The control signal to the counter 400 is based on either one of the following data items as shown in FIG. 5.

(a) Control data output by a phase control unit 370 that generates a control signal by the PID control

(b) Non-control data

A switch 381 selects one of the two data items as output data to a DAC (digital analog convertor) 382.

A selection signal is converted into an analog value by the DAC (digital analog convertor) 382, and a converted value thus obtained is input as a control voltage with respect to a VCO (voltage controlled oscillator) 383. The VCO 383 outputs an output signal having a predetermined frequency in accordance with the control voltage to the counter 400, to adjust the counter output.

Here, the switch 381 is a switch for performing switch control to output either one of the following data items.

(a) Control data output by the phase control unit 370 that generates the control signal by the PID control

(b) Non-control data

The switch 381 is controlled by an output of a comparator (Comp) 361 of a level window 360.

In the case where the reciprocation delay time of the synchronous packet transmitted to and received from the master apparatus is within a preset offset window, the comparator (Comp) 361 controls the switch 381 to output control data generated by the phase control unit 370 to the counter 400.

On the other hand, in the case where the reciprocation delay time of the synchronous packet is outside of the preset offset window, the switch 381 is controlled to output not the control data generated by the phase control unit 370 but the non-control data to the counter 400.

It should be noted that the non-control data is data for maintaining a current control state of the counter 400.

That is, the control for changing the output of the counter 400 is performed only in the case where the control data from the phase control unit 370 is selected by the switch 381.

In other words, only in the case where it is confirmed that the reciprocation delay time of the synchronous packet transmitted to and received from the master apparatus is within the preset offset window, the control data in accordance with the synchronous packet is generated by the phase control unit 370, and the control for the counter 400 is performed.

The processes of composition parts of the data processing unit 300 will be described.

A delay and offset calculation unit 310 measures the reciprocation delay time of the synchronous packet transmitted to and received from the master apparatus and calculates the phase offset between the master clock and the slave clock.

A network delay (NW delay (T2−T1)) calculation unit 311 and a network delay (NW delay (T4−T3)) calculation unit 312 calculate the delay time of the synchronous packet transmitted to and received from the master apparatus.

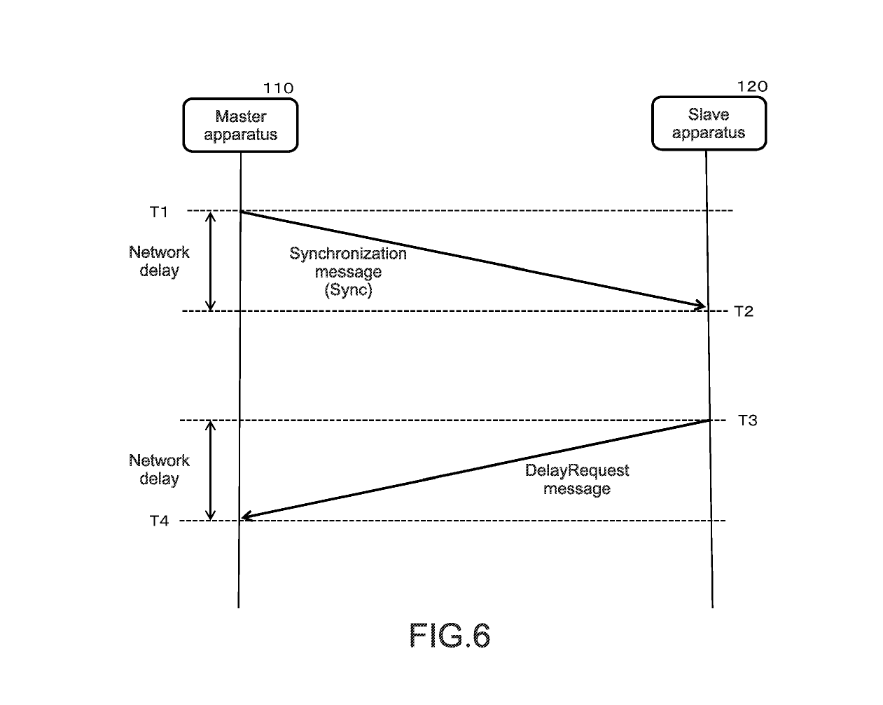

With reference to FIG. 6, a network delay time calculated by the network delay calculation units 311 and 312 will be described.

FIG. 6 is a diagram showing a simplified synchronous packet transmission and reception sequence shown in FIG. 3, in which only the transmission and reception of a packet used for the phase control are shown.

The network delay calculation units 311 and 312 measure the following two network delay times (1) and (2), respectively.

(1) Network delay time with respect to the “going” packet, which is a transmission packet to the slave apparatus 120 from the master apparatus 110 (T2−T1)

(2) Network delay time with respect to the “return” packet, which is a transmission packet to the master apparatus 110 from the slave apparatus 120 (T4−T3)

The network delay (NW delay (T2−T1)) calculation unit 311 shown in FIG. 6 measures the network delay time (T2−T1) with respect to the “going” packet of the above item (1).

The network delay (NW delay (T4−T3)) calculation unit 312 measures the network delay time (T4−T3) with respect to the “return” packet of the above item (2).

A subtracter 313 of the delay and offset calculation unit 310 subtracts the output value (T4−T3) of the network delay (NW delay (T4−T3)) calculation unit 312 from the output value (T2−T1) of the network delay (NW delay (T2-T1)) calculation unit 311, to obtain twice data of the phase offset between the master clock and the slave clock. That is, the twice offset value is obtained from the following Expression 4.

2*(Offset)=(T2−T1)−(T4−T3) Expression 4

The Expression 4 corresponds to an expression for calculating a twice value of the phase offset calculation expression shown as the Expression 2.

The output of the subtracter 313 is input to a divider (/2) 315, and the obtained value from the Expression 4 is divided by 2.

Through this process, the phase offset which is the same as in the case of the Expression 2 is calculated. The phase offset information is input to a switch 362 of the level window 360.

On the other hand, an adder 314 of the offset calculation unit 310 adds the output value (T2−T1) of the network delay (NW delay (T2−T1)) calculation unit 311 and the output value (T4−T3) of the network delay (NW delay (T4−T3)) calculation unit 312.

Through the addition process, the reciprocation delay time (2*Delay) of the packet between the master apparatus and the slave apparatus is calculated. That is, from the following Expression 5, the reciprocation delay time (2*Delay) is calculated.

2*(Delay)=(T2−T1)+(T4−T3) Expression 5

The information of the reciprocation delay time (2*Delay) calculated from the Expression 5 is input to the comparator (Comp) 361 of the level window 360. Further, the reciprocation delay time (2*Delay) information is also input to a minimum value selection unit 321 of a minimum value detection unit 320.

Next, the structure and the process of the minimum value detection unit 320 will be described.

The minimum value selection unit (min) 321 of the minimum value detection unit 320 inputs the reciprocation delay time (2*Delay) information calculated from the Expression 5 from the adder 314 of the delay and offset calculation unit 310.

The reciprocation delay time (2*Delay) information is input again to the minimum value selection unit (min) 321 via a delay processing unit (Z) 322.

The minimum value selection unit (min) 321 compares latest reciprocation delay time (2*Delay) information input from the adder 314 of the delay and offset calculation unit 310 with preceding reciprocation delay time (2*Delay) information input from the delay processing unit (Z) 322 and outputs reciprocation delay time (2*Delay) information having a smaller value as the minimum value (min).

The minimum value (min) corresponds to setting information of the minimum value (min) of the offset window described with reference to FIG. 4.

The minimum value (min) as the output of the minimum value selection unit (min) 321 is input to an adder 350.

Next, the structure and the process of an offset window generation unit 330 will be described.

In the offset window generation unit 330, a plurality of offset windows are stored in a memory thereof. Those offset windows are pieces of data which define different window widths. In the example shown in the figure, N offset windows 1 to N, 341 to 34N are provided.

A network measurement circuit 331 of the offset window generation unit 330 observes a condition of the communication network between the master apparatus and the slave apparatus. That is, a communication traffic in the network is measured.

The measurement information is input to an identification circuit 332, and the identification circuit 332 analyzes a load condition and a congestion condition of a current network on the basis of the measurement result.

The identification circuit 332 controls an offset window selection switch 333 on the basis of the identification result, determines an offset window applied to a packet selection, and outputs the offset window determined.

Specifically, for example, in the case where there is a large load on the network, an offset window having a larger window width is selected and output.

Further, in the case where there is a small load on the network, an offset window having a smaller window width is selected and output.

By performing such a process, it is possible to suppress a variation in number per unit time of the packets applicable to the control and perform stable control.

The adder 350 inputs the minimum value (min) from the minimum value detection unit 320, inputs information of the width of the selected offset window from the offset window generation unit 330, generates definition data of the offset window corresponding to a reciprocation delay amount of the packet applied to the control, and inputs the data to the comparator (Comp) 361 of the level window 360.

The data input from the adder 350 to the comparator (Comp) 361 corresponds to the reciprocation delay amount of the packet that defines the offset window and offset window information including data of (minimum value (min)) to (minimum value (min)+offset window width).

The comparator (Comp) 361 of the level window 360 inputs the offset window information from the adder 350 and inputs the reciprocation delay time (2*Delay) information measured on the basis of the latest synchronous packet from the delay and offset calculation unit 310.

The comparator (Comp) 361 compares those two pieces of information with each other. That is, the comparator determines whether the reciprocation delay time (2*Delay) information calculated on the basis of the latest synchronous packet is within the delay time defined by the offset window or not and controls the switches 362 and 381 in accordance with the determination information.

In the case where the reciprocation delay time (2*Delay) information calculated on the basis of the latest synchronous packet is within the delay time defined by the offset window, the switch 362 of the level window 360 is turned on, and the phase offset information calculated on the basis of the latest synchronous packet by the delay and offset calculation unit 310 is input to the phase control unit 370.

Further, the switch 381 is subjected to such a setting that the control data as the generation data from the phase control unit 370 is transferred to the counter 400.

On the other hand, in the case where the reciprocation delay time (2*Delay) information calculated on the basis of the latest synchronous packet is not within the delay time defined by the offset window, the switch 362 of the level window 360 is turned off, and such a setting that the phase offset information calculated on the basis of the latest synchronous packet by the delay and offset calculation unit 310 is not input to the phase control unit 370 is provided.

Further, for the switch 381, not the control data as the generation data from the phase control unit 370 but the non-control data is set to be transferred to the counter 400.

By the switch control described above, only such a packet that the reciprocation delay time is within the delay time defined by the offset window is selected, and the phase offset information calculated on the basis of the selected packet is applied, the control data thus generated is selected and applied, thereby controlling the counter 400.

However, in the structure shown in FIG. 5, in the offset window generation unit 330, the network measurement circuit 331 measures communication traffic and the like by monitoring the communication of the network, and in the identification circuit 332, it is necessary to perform a process for analyzing the load condition of the network on the basis of the measurement condition.

To provide the structure described above results in an increase of a circuit size of the apparatus and an increase of the cost, which is undesirable for the apparatus which is demanded to attain a size reduction and a cost reduction.

(4. About Process Example in which Sequential Scaling Process for Offset Window is Performed)

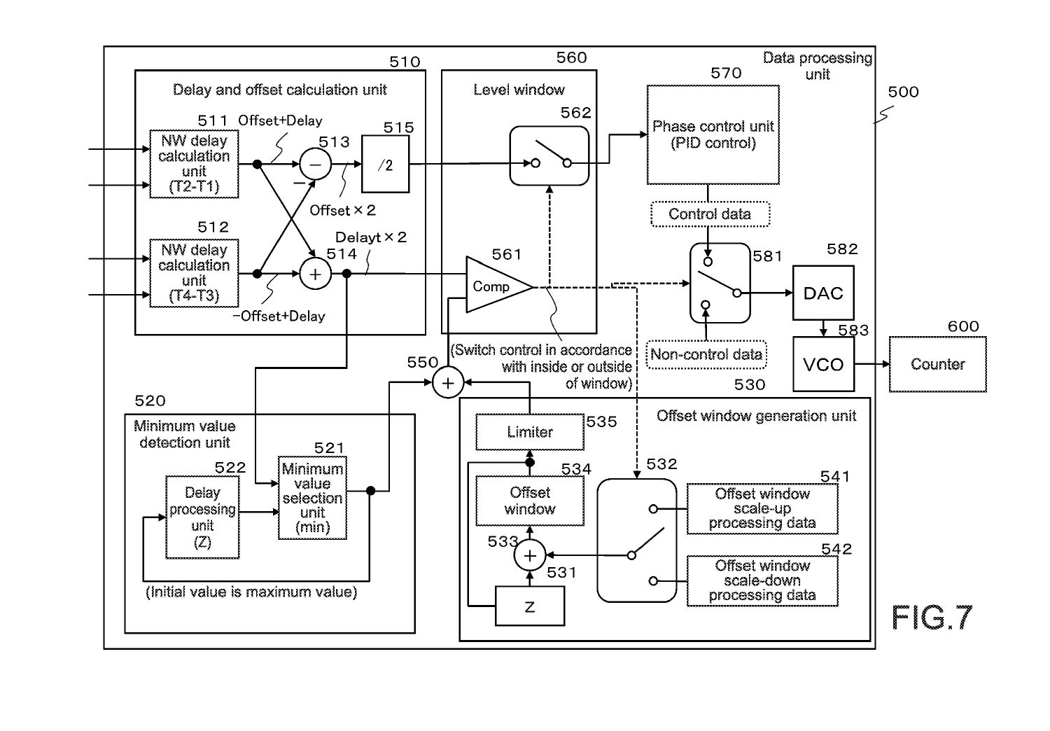

Next, a synchronous process performed in the communication apparatus according to the present disclosure will be described. FIG. 7 is a diagram showing an example of the structure of a data processing unit of the communication apparatus that performs a synchronous process in the communication apparatus according to the present disclosure, that is, a synchronous process accompanied by a sequential scaling process of the offset window.

A data processing unit 500 shown in FIG. 7 corresponds to the data processing unit 123 of the slave apparatus 120 shown in FIG. 1, for example.

As described above with reference to FIG. 3, the slave apparatus 120 transmits and receives, to and from the master apparatus 110, the synchronization packet of the synchronization message (Sync), the delay request (DelayRequest) message, and the like to perform the synchronous process.

The data processing unit 123 of the slave apparatus 120 calculates the phase offset and the frequency drift between the master clock (Mclk) and the slave clock (Sclk) from the Expressions 1 and 2 described above to generate a correction signal on the basis of the calculation result. The correction signal is input to the counter 122, a count value generated on the basis of the slave clock (Sclk) is controlled, thereby executing the synchronous process.

An example of a process to be described below is a process for controlling the phase offset between the master clock (Mclk) and the slave clock (Sclk), that is, the time difference between the master clock (Mclk) and the slave clock (Sclk).

The data processing unit 500 shown in FIG. 7 generates a control signal for controlling the phase offset between the master clock (Mclk) and the slave clock (Sclk), that is, the time difference therebetween and outputs the control signal to a counter 600.

In the structure shown in FIG. 7, like the structure shown in FIG. 5 described above, the control signal to the counter 600 is based on the following data items.

(a) Control data output by a phase control unit 570 that generates a control signal by the PID control

(b) Non-control data

A switch 581 selects one of the two data items as output data to a DAC (digital analog convertor) 582.

A selection signal is converted into an analog value by the DAC (digital analog convertor) 582, and a converted value thus obtained is input as a control voltage with respect to a VCO (voltage controlled oscillator) 583. The VCO 583 outputs an output signal having a predetermined frequency in accordance with the control voltage to the counter 600, to adjust the counter output.

Here, the switch 581 is a switch for performing switch control to output either one of the following data items.

(a) Control data output by the phase control unit 570 that generates a control signal by the PID control

(b) Non-control data

The switch 581 is controlled by an output of a comparator (Comp) 561 of a level window 560.

In the case where the reciprocation delay time of the synchronous packet transmitted to and received from the master apparatus is within a preset offset window, the comparator (Comp) 561 controls the switch 581 to output control data generated by the phase control unit 570.

On the other hand, in the case where the reciprocation delay time of the synchronous packet is outside of the preset offset window, the switch 581 is controlled to output not the control data generated by the phase control unit 570 but the non-control data to the counter 600.

It should be noted that the non-control data is data for maintaining a current control state of the counter 600.

That is, the control for changing the output of the counter 600 is performed only in the case where the control data from the phase control unit 570 is selected by the switch 581.

In other words, only in the case where it is confirmed that the reciprocation delay time of the synchronous packet transmitted to and received from the master apparatus is within the preset offset window, the control data in accordance with the synchronous packet is generated by the phase control unit 570, and the control for the counter 600 is performed.

The processes of composition parts of the data processing unit 500 will be described.

A delay and offset calculation unit 510 measures the reciprocation delay time of the synchronous packet transmitted to and received from the master apparatus and calculates the phase offset between the master clock and the slave clock.

A network delay (NW delay (T2−T1)) calculation unit 511 and a network delay (NW delay (T4−T3)) calculation unit 512 calculate the delay time of the synchronous packet transmitted to and received from the master apparatus.

Processes of the network delay calculation units 511 and 512 are the same as the processes of the network delay calculation units 311 and 312.

That is, the following network delay times described above with reference to FIG. 6 are calculated.

(1) Network delay time with respect to the “going” packet, which is a transmission packet to the slave apparatus 120 from the master apparatus 110 (T2−T1)

(2) Network delay time with respect to the “return” packet, which is a transmission packet to the master apparatus 110 from the slave apparatus 120 (T4−T3)

A subtracter 513 of the delay and offset calculation unit 510 subtracts the output value (T4−T3) of the network delay (NW delay (T4−T3)) calculation unit 512 from the output value (T2−T1) of the network delay (NW delay (T2-T1)) calculation unit 511, to calculate twice data of the phase offset between the master clock and the slave clock. That is, the twice offset value is obtained from the following Expression 4 described above.

2*(Offset)=(T2−T1)−(T4−T3) Expression 4

The phase offset information is input to the switch 562 of the level window 560.

On the other hand, an adder 514 of the offset calculation unit 510 adds the output value (T2−T1) of the network delay (NW delay (T2−T1)) calculation unit 511 and the output value (T4−T3) of the network delay (NW delay (T4−T3)) calculation unit 512.

Through the addition process, the reciprocation delay time (2*Delay) is calculated from the following Expression 5 described above.

2*(Delay)=(T2−T1)+(T4−T3) Expression 5

The information of the reciprocation delay time (2*Delay) calculated from the Expression 5 is input to the comparator (Comp) 561 of the level window 560. Further, the reciprocation delay time (2*Delay) information is also input to a minimum value selection unit 521 of a minimum value detection unit 520.

Next, the structure and the process of the minimum value detection unit 520 will be described.

The minimum value selection unit (min) 521 of the minimum value detection unit 520 inputs the reciprocation delay time (2*Delay) information calculated from the Expression 5 from the adder 514 of the delay and offset calculation unit 510.

The reciprocation delay time (2*Delay) information is input again to the minimum value selection unit (min) 521 via a delay processing unit (Z) 522.

The minimum value selection unit (min) 521 compares latest reciprocation delay time (2*Delay) information input from the adder 514 of the delay and offset calculation unit 510 with preceding reciprocation delay time (2*Delay) information input from the delay processing unit (Z) 522 and outputs reciprocation delay time (2*Delay) information having a smaller value as the minimum value (min).

The minimum value (min) corresponds to setting information of the minimum value (min) of the offset window described with reference to FIG. 4.

The minimum value detection unit 520 performs a process for updating the minimum value as an end portion of one of the offset window on the basis of the delay time data of the synchronous packets sequentially calculated.

The minimum value (min) as the output of the minimum value selection unit (min) 521 is input to an adder 550.

Next, the structure and the process of an offset window generation unit 530 will be described.

The offset window generation unit 530 has the structure different from the structure described above with reference to FIG. 5.

The offset window generation unit 530 stores an offset window scale-up processing data 541 and an offset window scale-down processing data 542 in a memory thereof. Those data items are data for scaling up or down the width of a current offset window.

The data of the width of the current offset window is an offset window 534 of the offset window generation unit 530. The offset window 534 is input to an adder 533 via a delay unit (z) 531.

In the adder 533, the width of the current offset window is adjusted.

That is, in the case where a window size control switch 532 is connected to the offset window scale-up processing data 541 side, in the adder 533, the offset window scale-up processing data 541 is added to the current offset window width, and the window width is increased. The offset window scale-up processing data 541 has a positive value as increased width information of the offset window.

On the other hand, in the case where the window size control switch 532 is connected to the offset window scale-down processing data 542 side, in the adder 533, the offset window scale-down processing data 542 is added to the current offset window width, and the window width is decreased. The offset window scale-down processing data 542 has a negative value as decreased width information of the offset window.

The updated offset window 534 the window width of which is scaled up or down is output to the adder 550 through a limiter 535.

The limiter 535 has a maximum width and a minimum width of the offset window, that is, an upper limit value and a lower limit value of the window width and performs control so that the width of the offset window falls within the range from the upper limit value to the lower limit value.

The window size control switch 532 is set by an output of the comparator (Comp) 561 of the level window 560.

The comparator (Comp) 561 of the level window 560 determines whether the reciprocation delay time (2*Delay) information calculated on the basis of the latest synchronous packet by the delay and offset calculation unit 510 is within the delay time defined by the offset window or not and controls the window size control switch 532 in accordance with the determination information.

In the case where the reciprocation delay time (2*Delay) information calculated on the basis of the latest synchronous packet is within the delay time defined by the offset window, the window size control switch 532 of the offset window generation unit 530 is set to the side of the offset window scale-down processing data 542.

That is, the process for decreasing the current window width is set to be performed.

On the other hand, in the case where the reciprocation delay time (2*Delay) information calculated on the basis of the latest synchronous packet is not within the delay time defined by the offset window, the window size control switch 532 of the offset window generation unit 530 is set to the side of the offset window scale-up processing data 541.

That is, the process for increasing the current window width is set to be performed.

As described above, in the case where the reciprocation delay time (2*Delay) information calculated on the basis of the latest synchronous packet is within the delay time defined by the current offset window, the offset window width generation unit 530 scales down the window width. In the case where the reciprocation delay time (2*Delay) information is not within the delay time defined by the current offset window, the offset window generation unit 530 scales up the window width. In this way, the sequential window size (width) updating process is performed.

By controlling the window size, the network measurement circuit and the analysis circuit described above with reference to FIG. 5 becomes unnecessary.

The updated offset window 534 obtained by scaling up or down the window width is output to the adder 550 via the limiter 535.

The limiter 535 has the maximum width and the minimum width of the offset window, that is, the upper limit value and the lower limit value of the window width and performs control so that the width of the offset window falls within the range from the upper limit value to the lower limit value.

The adder 550 inputs the minimum value (min) from the minimum value detection unit 520, inputs information of the width of the selected offset window from the offset window generation unit 530, generates definition data of the offset window corresponding to a reciprocation delay amount of the packet applied to the control, and inputs the data to the comparator (Comp) 561 of the level window 560.

The data input from the adder 550 to the comparator (Comp) 561 corresponds to the reciprocation delay amount of the packet that defines the offset window and offset window information including data of (minimum value (min)) to (minimum value (min)+offset window width).

The comparator (Comp) 561 of the level window 560 inputs the offset window information from the adder 550 and inputs the reciprocation delay time (2*Delay) information measured on the basis of the latest synchronous packet from the delay and offset calculation unit 510.

The comparator (Comp) 561 compares those two pieces of information with each other. That is, the comparator determines whether the reciprocation delay time (2*Delay) information calculated on the basis of the latest synchronous packet is within the delay time defined by the offset window or not and controls the window size control switch 532 in accordance with the determination information.

Further, the switches 562 and 581 are controlled.

In the case where the reciprocation delay time (2*Delay) information calculated on the basis of the latest synchronous packet is within the delay time defined by the offset window, the switch 562 of the level window 560 is turned on, and the phase offset information calculated on the basis of the latest synchronous packet by the delay and offset calculation unit 510 is input to the phase control unit 570.

Further, the switch 581 is subjected to such a setting that the control data as the generation data from the phase control unit 570 is transferred to the counter 600 side.

On the other hand, in the case where the reciprocation delay time (2*Delay) information calculated on the basis of the latest synchronous packet is not within the delay time defined by the offset window, the switch 562 of the level window 560 is turned off, and such a setting that the phase offset information calculated on the basis of the latest synchronous packet by the delay and offset calculation unit 510 is not input to the phase control unit 570 is provided.

Further, for the switch 581, not the control data as the generation data from the phase control unit 570 but the non-control data is set to be transferred to the counter 600 side.

Control for the counter 600 based on the switch control described above is performed.

That is, only a packet the reciprocation delay time of which is within the delay time defined by the offset window is selected, and the control data generated by applying the phase offset information calculated on the basis of the selected packet is selected and applied, thereby controlling the counter 600.

In the structure shown in FIG. 7, on the basis of the delay time information of the latest synchronous packet, the window size (width) of the offset window is controlled.

Accordingly, it is unnecessary to provide the network measurement circuit 331 and the identification circuit 332 described above with reference to FIG. 5 to the offset window generation unit 530, and thus the increase of the circuit size and cost is not caused, with the result that the size reduction and the cost reduction are attained.

Further, the width of the offset window is sequentially scaled up or down in accordance with the delay condition of the latest packet, with the result that it is possible to control the window size with the current state further reflected thereon. Further, in this structure, because the window size is sequentially scaled up and down, such a situation that the synchronous packet is not applied for a long time is reduced. As a result, the synchronous control is attained with higher accuracy.

(5. About Example of Offset Scaling Process Algorithm)

In the structure shown in FIG. 7, the offset window scale-up processing data 541 and the offset window scale-down processing data 542 are data items for adjusting the size (width) of the current offset window.

Various settings for those data items can be provided.

For example, the offset window scale-up processing data 541 is set to be data for an increase by a fixed time width t1, and the offset window scale-down processing data 542 is set to be data for a decrease by a fixed time width t2.

For example, the current value of the offset window width is set to OffsetWindow_cur, the value of the width of the updated offset window is set to OffsetWindow_upd, the offset window scale-up processing data 541 is set to OffsetWindow_inc, and the offset window scale-down processing data 542 is set to OffsetWindow_dec.

OffsetWindow_inc>0 and OffsetWindow_dec<0 are satisfied.

At this time, in the case where the reciprocation delay time (2*Delay) information calculated on the basis of the latest synchronous packet is not within the delay time defined by the current offset window (OffsetWindow_cur), the offset window width is updated on the basis of the following expression.

OffsetWindow_upd=OffsetWindow_cur+OffsetWindow_inc

Through the above update process, the offset window width is increased.

On the other hand, in the case where the reciprocation delay time (2*Delay) information calculated on the basis of the latest synchronous packet is within the delay time defined by the current offset window (OffsetWindow_cur), the offset window width is updated on the basis of the following expression.

OffsetWindow_upd=OffsetWindow_cur+OffsetWindow_dec

Through the above update process, the offset window width is decreased.

When the algorithm mentioned above is executed, in the case where the network delay time of the synchronous packet is within the current offset window, the data processing unit 500 shown in FIG. 7 decreases the width of the current offset window by a predefined fixed width. On the other hand, in the case where the network delay time of the synchronous packet is not within the current offset window, the data processing unit 500 increases the width of the current offset window by the predefined fixed width.

Alternatively, the offset window scale-up processing data 541 is set to be data for an increase by no of the current window width, for example, by 10%, and the offset window scale-down processing data 542 is set to be data for a decrease by m % of the current window width, for example, by 10%.

The various settings as described above can be provided.

When the algorithm described above is executed, in the case where the network delay time of the synchronous packet is within the current offset window, the data processing unit 500 shown in FIG. 7 decreases the width of the current offset window by a predefined fixed decrease rate. On the other hand, in the case where the network delay time of the synchronous packet is not within the current offset window, the data processing unit 500 increases the width of the current offset window by the predefined fixed increase rate.

Further, the following setting may be provided. In the case where the scale-up process is successively performed, the scale-up width is changed depending on the number of succession times, and in the case where the scale-down process is successively performed, the scale-down width is changed depending on the number of succession times.

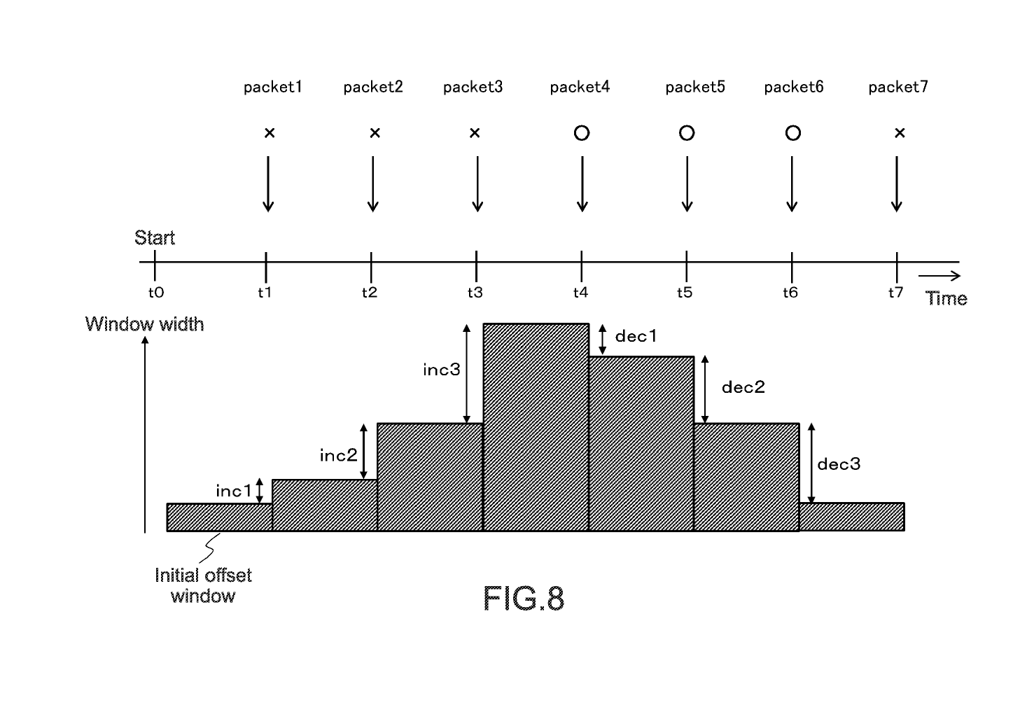

With reference to FIG. 8, the window size control algorithm will be described.

On an upper stage of FIG. 8, whether the reciprocation delay times measured on the basis of the synchronous packets 1 to 7 are within the current offset window (o) or not (x) is indicated in chronological order.

The synchronous packets 1 to 7 are packets received at times t1 to t7.

On a lower stage of FIG. 8, a transition of the width of the offset window is shown.

It should be noted that an initial offset window width is set to a width predefined. The initial offset window width is indicated at time t0 to t1 in the figure.

The delay time of the synchronous packet 1 measured at the time t1 is (x), that is, is not within the current offset window.

In this case, at the time t1, the width of the initial offset window indicated at the time t0 to t1 is scaled up by a size of inc1 shown in the figure, with the result that the window width indicated at the time t1 to t2 is obtained.

Next, the delay time of the synchronous packet 2 measured at the time t2 is also (x), that is, is not within the current offset window.

The delay times of the synchronous packets are outside of the offset window two times in a row.

In this case, the width of the offset window indicated at the time t1 to t2 is scaled up by the size of (inc2) shown in the figure, with the result that the window width indicated at the time t2 to t3 is obtained.

inc1<inc2 is satisfied, so the process of scaling up the larger width of the window size than the initial scale-up width is performed.

Next, the delay time of the synchronous packet 3 measured at the time t3 is also (x), that is, is not within the current offset window.

The delay times of the synchronous packets are outside of the offset window three times in a row.

In this case, the width of the offset window indicated at the time t2 to t3 is scaled up by the size of (inc3) shown in the figure, with the result that the window width indicated at the time t3 to t4 is obtained.

inc1<inc2<inc3 is satisfied, so the process of scaling up the larger width of the window size than the initial and second scale-up widths is performed.

In the case where the processes mentioned above are performed, the offset window scale-up processing data shown in FIG. 7 is set as data sequentially increased in accordance with the number of succession times of the scale-up process.

Next, the delay time of the synchronous packet 4 measured at the time t4 is (o), that is, is within the current offset window.

After the scale-up process of the window size, the delay time of the synchronous packet falls within the offset window for the first time.

In this case, the width of the offset window indicated at the time t3 to t4 is scaled down by the size of (dec1) shown in the figure, with the result that the window width indicated at the time t4 to t5 is obtained.

Next, the delay time of the synchronous packet 5 measured at the time t5 is also (o), that is, is within the current offset window.

The delay times of the synchronous packets are within the offset window two times in a row.

In this case, the width of the offset window indicated at the time t4 to t5 is scaled down by the size of (dec2) shown in the figure, with the result that the window width indicated at the time t5 to t6 is obtained.

The relationship between the degrees of the decrease width of the window (dec1) and (dec2) is dec1<dec2. Therefore, the process of scaling down the larger width of the window size than the initial scale-down width is performed.

Next, the delay time of the synchronous packet 6 measured at the time t6 is also (o), that is, is within the current offset window.

The delay times of the synchronous packets are within the offset window three times in a row.

In this case, the width of the offset window indicated at the time t5 to t6 is scaled down by the size of (dec3) shown in the figure, with the result that the window width indicated at the time t6 to t7 is obtained.

The relationship among the degrees of the decrease width of the window (dec1), (dec2), and (dec3) is dec1<dec2<dec3. Therefore, the process of scaling down the larger width of the window size than the first and second scale-down widths is performed.

In the case where the above processes are performed, the offset window scale-down processing data shown in FIG. 7 is set as data that the degree of the decrease of the window width is increased sequentially in accordance with the number of succession times of the scale-down processes.

In the case where the scale-up or the scale-down is successively performed as described above, the degree of the increase and the degree of the decrease are set to be sequentially larger.

By performing the process as described above, it is possible to obtain an optimal window size more quickly.

It should be noted that in the example shown in FIG. 8, the number of successive processes of scaling up and scaling down the window size is set to three times, but the same process may be performed in the setting of four times or more.

Alternatively, a certain maximum scale-up width and a certain maximum scale-down width may be defined. For successive scale-up processes for a predetermined number of times or more, the maximum scale-up width defined may be successively applied, and for successive scale-down processes for a predetermined number of times or more, the maximum scale-down width defined may be successively applied.

(6. Conclusion of Structure of Present Disclosure)

The embodiment of the present disclosure is described above in detail with reference to the specific examples. It is obvious that persons in the art can modify or substitute the embodiment without departing from the gist of the present disclosure, and limited interpretation should not be carried out. That is, the embodiment of the present disclosure is described, and a limited interpretation of the present disclosure should not be carried out. To determine the gist of the present disclosure, the claims should be taken into consideration.

It should be noted that the present disclosure can take the following configurations.

(1) A communication apparatus, including:

a data processing unit configured to perform a clock synchronous process between the communication apparatus and a communication correspondent apparatus; and

a communication unit configured to perform communication with the communication correspondent apparatus, in which

the data processing unit compares, when the clock synchronous process accompanied by transmission and reception of a synchronous packet to and from the communication correspondent apparatus is performed, an offset window that defines a permissible delay time range of a packet applied to the synchronous process and a network delay time of the synchronous packet with each other, selects the synchronous packet having the network delay time within the offset window, and applies phase offset information calculated from the synchronous packet selected, to perform phase control, and

the data processing unit performs an offset window width update process of decreasing a width of a current offset window in a case where the network delay time of the synchronous packet is within the current offset window and increasing the width of the current offset window in a case where the network delay time of the synchronous packet is outside of the current offset window.

(2) The communication apparatus according to Item (1), in which

the data processing unit decreases the width of the current offset window by a fixed width predefined in a case where the network delay time of the synchronous packet is within the current offset window, and

the data processing unit increases the width of the current offset window by the fixed width predefined in a case where the network delay time of the synchronous packet is outside of the current offset window.

(3) The communication apparatus according to Item (1), in which

the data processing unit decreases the width of the current offset window by a fixed decrease rate predefined in a case where the network delay time of the synchronous packet is within the current offset window, and

the data processing unit increases the width of the current offset window by a fixed increase rate predefined in a case where the network delay time of the synchronous packet is outside of the current offset window.

(4) The communication apparatus according to Item (1), in which

the data processing unit sets an increase of the width of the offset window to be larger in accordance with a successive count of an increasing process for the width of the offset window, and

the data processing unit sets a decrease of the width of the offset window to be larger in accordance with a successive count of a decreasing process for the width of the offset window.

(5) The communication apparatus according to any one of Items (1) to (4), in which

the data processing unit performs the increasing and decreasing process for the width of the offset window within a range from an upper limit value to a lower limit value of the offset window width predefined.

(6) The communication apparatus according to any one of Items (1) to (5), in which

the data processing unit calculates, as the network delay, a sum of a time period necessary for the reception of the synchronous packet from the communication correspondent apparatus and a time period necessary for the transmission of the synchronous packet to the communication correspondent apparatus.

(7) The communication apparatus according to any one of Items (1) to (6), in which

the data processing unit updates a minimum value as an end of the offset window on the basis of delay time data of the synchronous packet which is calculated sequentially.

(8) A communication system, including:

a first communication apparatus; and

a second communication apparatus configured to perform communication with the first communication apparatus, in which

the first communication apparatus includes
a data processing unit configured to perform a clock synchronous process between the first communication apparatus and the second communication apparatus, and
a communication unit configured to perform communication with the second communication apparatus,

the data processing unit compares, when the clock synchronous process accompanied by transmission and reception of a synchronous packet to and from the second communication apparatus is performed, an offset window that defines a permissible delay time range of a packet applied to the synchronous process and a network delay time of the synchronous packet with each other, selects the synchronous packet having the network delay time within the offset window, and applies phase offset information calculated from the synchronous packet selected, to perform phase control, and

the data processing unit performs an offset window width update process of decreasing a width of a current offset window in a case where the network delay time of the synchronous packet is within the current offset window and increasing the width of the current offset window in a case where the network delay time of the synchronous packet is outside of the current offset window.

Further, the method of performing the process in the apparatus and the system described above and the program for performing the process are also included in the structure of the present disclosure.

Furthermore, the series of processes described above can be performed by hardware, software or a composite structure of the hardware and the software. In the case where the process is performed by the software, it is possible to install the program, in which a process sequence is recorded, to a memory in a computer incorporated in dedicated hardware and execute the program or install the program to a general-purpose computer capable of executing various processes and execute the program. For example, the program can be recorded in advance in a recording medium. it is possible to install the program into a computer from the recording medium or receive the program via a network such as a LAN (local area network) and the Internet and install the program to a recording medium such as a built-in hard disk.

It should be noted that the various processes described in the specification may not necessarily be performed in a chronological order according to the description. The processes may be performed in parallel or individually as necessary or in accordance with the processing ability of the apparatus that performs the processes. Further, in the specification, the system means a logically assembled structure of the plurality of apparatuses, and the apparatuses of the structures are not necessarily be in the same casing.

As described above, with the structure according to the embodiment of the present disclosure, the highly accurate clock synchronous process is attained in the communication apparatus.

Specifically, the communication apparatus includes a data processing unit configured to perform a clock synchronous process between the communication apparatus and a communication correspondent apparatus, and a communication unit configured to perform communication with the communication correspondent apparatus. The data processing unit compares, when the clock synchronous process accompanied by transmission and reception of a synchronous packet to and from the communication correspondent apparatus is performed, an offset window that defines a permissible delay time range of a packet applied to the synchronous process and a network delay time of the synchronous packet with each other, selects the synchronous packet having the network delay time within the offset window, and applies phase offset information calculated from the synchronous packet selected, to perform phase control, and the data processing unit performs an offset window width update process of decreasing a width of a current offset window in a case where the network delay time of the synchronous packet is within the current offset window and increasing the width of the current offset window in a case where the network delay time of the synchronous packet is outside of the current offset window.

With this structure, under the setting of the optimal window width which fits to the current condition, it is possible to select the synchronous packet for performing reliable synchronous control and perform the highly accurate clock synchronous process.

The present disclosure contains subject matter related to that disclosed in Japanese Priority Patent Application JP 2012-165355 filed in the Japan Patent Office on Jul. 26, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A communication apparatus, comprising:
a data processing unit configured to perform a clock synchronous process between the communication apparatus and a communication correspondent apparatus; and
a communication unit configured to perform communication with the communication correspondent apparatus, wherein
the data processing unit compares, when the clock synchronous process accompanied by transmission and reception of a synchronous packet to and from the communication correspondent apparatus is performed, an offset window that defines a permissible delay time range of a packet applied to the synchronous process and a network delay time of the synchronous packet with each other, selects the synchronous packet having the network delay time within the offset window, and applies phase offset information calculated from the synchronous packet selected, to perform phase control, and
the data processing unit performs an offset window width update process of decreasing a width of a current offset window in a case where the network delay time of the synchronous packet is within the current offset window and increasing the width of the current offset window in a case where the network delay time of the synchronous packet is outside of the current offset window.

2. The communication apparatus according to claim 1, wherein
the data processing unit decreases the width of the current offset window by a fixed width predefined in a case where the network delay time of the synchronous packet is within the current offset window, and
the data processing unit increases the width of the current offset window by the fixed width predefined in a case where the network delay time of the synchronous packet is outside of the current offset window.

3. The communication apparatus according to claim 1, wherein
the data processing unit decreases the width of the current offset window by a fixed decrease rate predefined in a case where the network delay time of the synchronous packet is within the current offset window, and
the data processing unit increases the width of the current offset window by a fixed increase rate predefined in a case where the network delay time of the synchronous packet is outside of the current offset window.

4. The communication apparatus according to claim 1, wherein
the data processing unit sets an increase of the width of the offset window to be larger in accordance with a successive count of an increasing process for the width of the offset window, and
the data processing unit sets a decrease of the width of the offset window to be larger in accordance with a successive count of a decreasing process for the width of the offset window.

5. The communication apparatus according to claim 1, wherein
the data processing unit performs the increasing and decreasing process for the width of the offset window within a range from an upper limit value to a lower limit value of the offset window width predefined.

6. The communication apparatus according to claim 1, wherein
the data processing unit calculates, as the network delay, a sum of a time period necessary for the reception of the synchronous packet from the communication correspondent apparatus and a time period necessary for the transmission of the synchronous packet to the communication correspondent apparatus.

7. The communication apparatus according to claim 1, wherein
the data processing unit updates a minimum value as an end of the offset window on the basis of delay time data of the synchronous packet which is calculated sequentially.

8. A communication system, comprising:
a first communication apparatus; and
a second communication apparatus configured to perform communication with the first communication apparatus, wherein
the first communication apparatus includes
a data processing unit configured to perform a clock synchronous process between the first communication apparatus and the second communication apparatus, and
a communication unit configured to perform communication with the second communication apparatus,
the data processing unit compares, when the clock synchronous process accompanied by transmission and reception of a synchronous packet to and from the second communication apparatus is performed, an offset window that defines a permissible delay time range of a packet applied to the synchronous process and a network delay time of the synchronous packet with each other, selects the synchronous packet having the network delay time within the offset window, and applies phase offset information calculated from the synchronous packet selected, to perform phase control, and
the data processing unit performs an offset window width update process of decreasing a width of a current offset window in a case where the network delay time of the synchronous packet is within the current offset window and increasing the width of the current offset window in a case where the network delay time of the synchronous packet is outside of the current offset window.

9. A synchronous processing method for performing a clock phase synchronous process in a communication apparatus including a data processing unit configured to perform a clock synchronous process between the communication apparatus and a communication correspondent apparatus and a communication unit configured to perform communication with the communication correspondent apparatus, the synchronous processing method comprising:
comparing, when the clock synchronous process accompanied by transmission and reception of a synchronous packet to and from the communication correspondent apparatus is performed, an offset window that defines a permissible delay time range of a packet applied to the synchronous process and a network delay time of the synchronous packet with each other, selecting the synchronous packet having the network delay time within the offset window, and applying phase offset information calculated from the synchronous packet selected, to perform phase control by the data processing unit; and
performing an offset window width update process of decreasing a width of a current offset window in a case where the network delay time of the synchronous packet is within the current offset window and increasing the width of the current offset window in a case where the network delay time of the synchronous packet is outside of the current offset window by the data processing unit.

10. A program causing a clock phase synchronous process to be performed in a communication apparatus including a data processing unit configured to perform a clock synchronous process between the communication apparatus and a communication correspondent apparatus and a communication unit configured to perform communication with the communication correspondent apparatus, the program causing the data processing unit to perform the steps of
comparing, when the clock synchronous process accompanied by transmission and reception of a synchronous packet to and from the communication correspondent apparatus is performed, an offset window that defines a permissible delay time range of a packet applied to the synchronous process and a network delay time of the synchronous packet with each other, selecting the synchronous packet having the network delay time within the offset window, and applying phase offset information calculated from the synchronous packet selected, to perform phase control by the data processing unit, and
performing an offset window width update process of decreasing a width of a current offset window in a case where the network delay time of the synchronous packet is within the current offset window and increasing the width of the current offset window in a case where the network delay time of the synchronous packet is outside of the current offset window by the data processing unit.
